(19) United States
(12) Patent Application Publication
(10) Pub. No.: US 2026/0330512 A1
(43) Pub. Date: Oct. 22, 2026

(54) System and method for selecting and ranking advertisements within the Project Lloto B

(71) Applicant: Armando ALIKO, Tirana (AL)

(72) Inventor: Armando ALIKO, Tirana (AL)

(21) Appl. No.: 19/162,943

(22) PCT Filed: Nov. 24, 2024
(86) PCT No.: PCT/AL2025/000001

§ 371 Date: Oct. 1, 2025

(30) Foreign Application Priority Data
Dec. 2, 2023 (AL) AL/P/2023/443

(51) Int. Cl. G06Q 30/0241

(52) U.S. Cl. CPC G06Q 30/0277

(57) ABSTRACT

The invention relates to a system and method for the automatic selection and ranking of audiovisual advertisements intended for television and digital broadcasting. The system includes a device containing an image processor, a set of servers, a VGA adapter, and a scoring mechanism, which work in cooperation with an online platform to process and rank the advertisements. The method of the invention comprises steps of uploading advertisements, registering users, storing data on servers, analyzing the content based on seven predefined criteria, and the final ranking of the advertisements. The system and method ensure transparency, efficiency, and avoidance of subjectivity in the evaluation of advertising content.

### 1. PURPOSE OF THE INVENTION

The purpose of this invention is to create a system and method that identifies, evaluates, and ranks advertisements based on seven clear criteria, using a device for selecting and ranking advertisements which consists of an image processor and multiple servers. Additionally, a VGA adapter is used as an accessory, which connects to the computing unit, along with a scoring mechanism system. All these components enable impartial decision-making through a physical interface and dedicated software. This method provides transparent results for all participants.

### 2. TECHNICAL FIELD

The invention relates to the field of the television industry, specifically to a system and method for selecting and ranking advertisements and TV spots through a system that utilizes a device composed of an image processor and multiple servers. A VGA adapter is used as an accessory, which connects to the computing part, along with a scoring mechanism system. This method also applies artificial intelligence operations to analyze audiovisual content based on a set of predefined criteria. The invention is beneficial in the television industry.

### 3. BACKGROUND OF THE INVENTION

Currently, there are platforms that allow the uploading and distribution of advertisements, but the selection and evaluation process is typically performed manually or based on very simplified criteria, such as the number of views, clicks, etc. This leaves room for subjectivity, lack of transparency, and inefficiency in selecting higher-quality content. Presently, advertising is often arranged through call centers, by calling potential clients and inviting them, for a fee, to sign contracts to advertise their businesses.

### 4. OBJECT OF PROTECTION

The object of protection includes a system and method for selecting and ranking advertisements, consisting of an image processor and multiple servers. A VGA adapter is used as an accessory, which connects to the computing unit, and a scoring mechanism system.

### 5. PROBLEM SOLVED BY THE INVENTION

The invention provides a solution through the complete automation of advertisement selection and ranking, via a system and method that ensures transparency for all participating entities. Advertisement selection is conducted objectively, based on a scoring system, thus eliminating human influence and potential bias. This method allows for efficient use of available advertisement time, significantly reducing subjectivity and favoritism in the selection process.

Furthermore, within this system and method, every participant emerges as a beneficiary-either with their advertisement spot published in environments such as commercial centers, on the official Lloto B website, or through monetary gain.

### SUMMARY OF THE INVENTION

The invention consists of a system and method for selecting advertisements and spots, using a method and system specifically designed for the selection and ranking of advertisements. This system includes a device for selecting and ranking advertisements, composed of an image processor and multiple servers. Additionally, a VGA adapter is used as an accessory, which connects to the computing unit, along with a scoring mechanism system.

This invention ensures a system for selecting and ranking advertisements, incorporating a device consisting of an image processor and multiple servers. A VGA adapter is used as an accessory connected to the computing unit, along with a scoring system mechanism. The server system transfers information uploaded through the LLOTO B portal to the advertisement selection and ranking device. Another server system processes the final transfer of advertisements through the scoring mechanism. At the end of the process, advertisements are ranked based on the points they have received.

The system also includes a filtering function that allows any user to search the internet for the desired advertisement using the business name as a search term. Non-winning participants will receive monetary compensation. The system for selecting and ranking advertisements includes a majority of servers that facilitate the transfer from the device to the scoring mechanism. The device is adapted to provide a connection with the scoring mechanism. The scoring mechanism is based on seven criteria: Clarity of the advertising message, originality and creativity of the advertisement, structure and pacing, visual appearance and composition (direction), music and voice, audience relevance, emotional impact. This type of mechanism serves to rank the winners.

From another perspective, the invention provides a method for selecting and ranking advertisements, which includes the following steps: Development of an e-LLOTO B platform and construction of a scoring system mechanism linked to the advertisement selection and ranking device; uploading advertisements to the e-LLOTO B portal; registration of businesses on the e-LLOTO B portal; registration and transmission of received advertisements and spots into the portal's database; registration of participants as subscribers who applied through the portal; storage of advertisements on the central server of e-LLOTO B; users can search, via the website, for the type of advertisement they want using filters; advertisements are selected and ranked through the scoring system based on the seven criteria; daily publication of ranked advertisements on the official Lloto B website.

This method aims to ensure that all participants become winners—either by receiving 30 seconds of television time to present their advertisement or through monetary reward.

The ranking of winners and participants is made transparent to all applicants. It is not required for the videos to be in high resolution to be declared winners. Through this transparent scoring system, participants will be ranked accordingly, and each advertisement will be scored based on the following 7 criteria: advertising message clarity, originality and creativity, structure and pacing, visual appearance and direction, music and voice, audience relevance, and emotional impact.

If there are 50,000 advertisement submissions, this method operates by ranking all business representatives with a serial number from 1 to 50,000. Each advertisement spot is assigned a 30-second ad time, which is generated by the algorithm.

Businesses communicate with the Lloto B system through the e-Lloto B portal. Business registration is done via the official Lloto B website. Applicants apply and upload their advertisements through the e-Lloto B portal. All submitted advertisements are stored and processed on the Lloto B server for a period of one month.

To achieve the aforementioned objective and address the identified problem, the invention offers a solution through full automation of the advertisement selection and ranking process, using a system and method that ensures transparency for all involved entities. Advertisement selection is conducted objectively, based on an algorithm that evaluates content using seven predefined criteria (as mentioned above). Additionally, within this system and method, all participants are considered winners-either by having their advertisement published in public spaces, commercial centers, or on the official Lloto B website, or by receiving a monetary reward.

1. A system for selecting and ranking advertisements, comprising:
(a) a device for selecting and ranking advertisements, including an image processor;
(b) a set of servers configured to store and process advertisement data;
(c) a VGA adapter connected to the computing unit for data transmission;
(d) a scoring mechanism system that evaluates advertisements based on seven content-related criteria;
(e) a physical and software interface for managing the selection and ranking process.

2. The system of claim 1, wherein the scoring mechanism is configured to automatically evaluate advertisements based on seven criteria: message clarity, originality, structure, visual appearance, music, audience relevance, and emotional impact.

3. The system of claim 1, wherein the servers are divided into functional modules, with one group of servers managing data storage and another group handling the processing and analysis of advertisements.

4. The system of claim 1, wherein the VGA adapter enables the transmission of visual signals to output devices for visual inspection of advertisements.

5. The system of claim 1, wherein the software interface includes an online platform (e-LLOTO B) through which users can upload advertisements, submit applications, and monitor ranking results.

6. A method for the automated selection and ranking of advertisements, comprising the steps of:
(a) uploading advertisements to an online platform (e-LLOTO B);
(b) registering businesses and users in the system;
(c) storing advertisements on a central server;
(d) analyzing the advertisements through a scoring mechanism based on seven criteria;
(e) ranking the advertisements according to the points awarded;
(f) announcing the winners and distributing the rewards.

7. The method of claim 6, wherein users can search for advertisements through a filter on the e-LLOTO B platform, using the business name as a search term.

8. The method of claim 6, wherein the selected advertisements earn the right to be broadcast on television in 30-second intervals or receive monetary rewards.

9. The method of claim 6, wherein each advertisement is processed by an algorithm that assigns scores for each of the seven criteria and calculates a total score for ranking purposes.

10. The method of claim 6, wherein the entire process is carried out automatically, without human intervention, ensuring transparency and eliminating subjectivity in advertisement selection.
